(19) United States
(12) Patent Application Publication
(10) Pub. No.: US 2010/0074272 A1
(43) Pub. Date: Mar. 25, 2010

(54) COMMUNICATION PROTOCOL DETECTION SYSTEM AND METHOD

(75) Inventor: SHEN-AN CHEN, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: FOXNUM TECHNOLOGY CO., LTD., Tucheng City (TW)

(21) Appl. No.: 12/269,048

(22) Filed: Nov. 12, 2008

(30) Foreign Application Priority Data
Sep. 25, 2008 (CN) 200810304662.2

(51) Int. Cl. H04J 3/22

(52) U.S. Cl. 370/465

(57) ABSTRACT

A communication protocol detection system includes an active detection terminal and a passive detection terminal. The active detection terminal includes a first communication interface, a command sending module, and a response receiving module. The passive detection terminal includes a second communication interface, a command receiving module, and a response sending module. The command sending module is for sending a plurality of detection commands in sequence to the passive detection terminal via the first communication interface. The command receiving module is for receiving detection commands in sequence via the second communication interface, and sending detection commands to the response sending module. The response sending module is for determining whether a currently received detection command can be identified. If the currently received detection command can be identified, the response sending module sends a response to the active detection terminal to make the command sending module stop sending detection commands.

### BACKGROUND

1. Technical Field

The present disclosure relates to systems and methods for detecting communication protocols and, particularly, to a system and a method for detecting a communication protocol to establish communication between two communication terminals.

2. Description of Related Art

Communication systems are widely used nowadays. One such communication system usually includes an active communication terminal and a passive communication terminal. The active and passive communication terminals have their respective communication protocols. For example, before the active communication terminal communicates with the passive communication terminal, the active communication terminal must identify a type of the communication protocol of the passive communication terminal.

Generally, a technician may manually identify communication protocol type of the passive communication terminal by analyzing a protocol instruction book of the passive communication terminal. However, if the protocol instruction book is missing at this time, it will be difficult to establish communication between the active and passive terminals.

What is needed, therefore, it is to provide a communication protocol detection system and method to overcome the above described shortcomings.

### BRIEF DESCRIPTION OF THE DRAWINGS

FIG. 1 is a block diagram of an exemplary embodiment of a communication protocol detection system.

FIG. 2 is a flowchart of an exemplary embodiment of a communication protocol detection method for implementing the system of FIG. 1.

### DETAILED DESCRIPTION

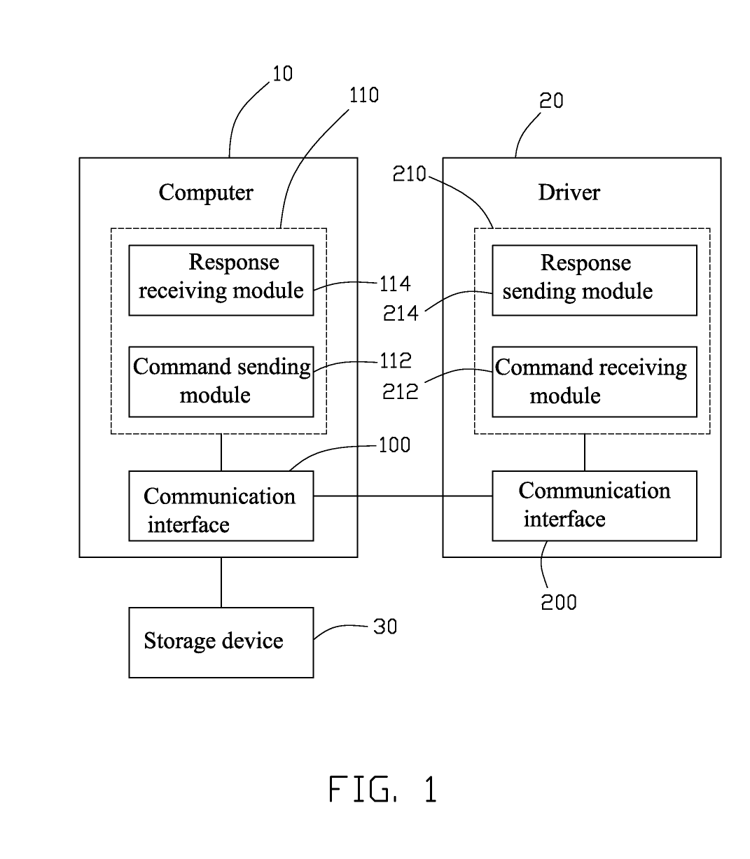

Referring to FIG. 1, an exemplary embodiment of a communication protocol detection system includes an active detection terminal such as a computer 10, a passive detection terminal such as a driver 20 for controlling a mechanical device operating, and a storage device 30. The computer 10 includes a communication interface 100 and a processing module 110. The processing module 110 includes a command sending module 112 and a response receiving module 114. The driver 20 includes a communication interface 200 and a processing module 210. The processing module 210 includes a command receiving module 212 and a response sending module 214. When the computer 10 communicates with the driver 20, the communication interfaces 100 and 200 are connected to each other.

The command sending module 112 is configured for numbering a plurality of detection commands, and sending each detection command to the driver 20 via the communication interface 100 by one numbered command at a predetermined time interval until receiving a stop command from the response receiving module 114. The predetermined time interval may be 40 ms or other values. Each detection command corresponding to each communication protocol as shown in tables 1 and 2 stored in the storage device 30. Each detection command includes a transmission rate and a packet mode. The transmission rate may be 4800 bps, 9600 bps, 19200 bps, 38400 bps, 57600 bps, or 115200 bps. Each transmission rate corresponds to a plurality of packet modes. The packet mode may be an American Standard Code for Information Interchange (ASCII) packet mode or a Remote Terminal Unit (RTU) packet mode.

TABLE 1
Communication Protocol of ASCII Packet Mode

| packet | packet | packet | packet | | |
|---|---|---|---|---|---|
| mode | mode | mode | mode | | |
| (rate = | (rate = | (rate = | (rate = | packet mode | packet mode |
| 115200 | 9600 | 38400 | 4800 | (rate = 57600 | (rate = 19200 |
| bps) | bps) | bps) | bps) | bps) | bps) |
| N, 7, 2 | N, 7, 2 | N, 7, 2 | N, 7, 2 | N, 7, 2 | N, 7, 2 |
| E, 7, 1 | E, 7, 1 | E, 7, 1 | E, 7, 1 | E, 7, 1 | E, 7, 1 |
| O, 7, 1 | O, 7, 1 | O, 7, 1 | O, 7, 1 | O, 7, 1 | O, 7, 1 |
| N, 8, 2 | N, 8, 2 | N, 8, 2 | N, 8, 2 | N, 8, 2 | N, 8, 2 |
| E, 8, 1 | E, 8, 1 | E, 8, 1 | E, 8, 1 | E, 8, 1 | E, 8, 1 |
| O, 8, 1 | O, 8, 1 | O, 8, 1 | O, 8, 1 | O, 8, 1 | O, 8, 1 |

TABLE 2
Communication Protocol of RTU Packet Mode

| packet | packet | packet | packet | | |
|---|---|---|---|---|---|
| mode | mode | mode | mode | | |
| (rate = | (rate = | (rate = | (rate = | packet mode | packet mode |
| 38400 | 9600 | 57600 | 4800 | (rate = 115200 | (rate = 19200 |
| bps) | bps) | bps) | bps) | bps) | bps) |
| N, 8, 2 | N, 8, 2 | N, 8, 2 | N, 8, 2 | N, 8, 2 | N, 8, 2 |
| E, 8, 1 | E, 8, 1 | E, 8, 1 | E, 8, 1 | E, 8, 1 | E, 8, 1 |
| O, 8, 1 | O, 8, 1 | O, 8, 1 | O, 8, 1 | O, 8, 1 | O, 8, 1 |

Take an ASCII packet mode (O, 7, 1), (N, 7, 2) or a RTU packet mode (E, 8, 1) as examples, here 7 or 8 indicates that a data length of a packet is 7 bits or 8 bits, O, E, and N indicate odd, even and no parity check for the packet, 1 or 2 indicates a 1 bit or 2 bits time interval between transmitting two adjacent packets, where 1 bit time interval is equal to 1 divided by value of transmission rate.

The command receiving module 212 is configured for receiving the detection commands from the command sending module 112 via the communication interfaces 100 and 200, and sending the detection commands to the response sending module 214.

The response sending module 214 is configured for comparing a currently received detection command with a predetermined command to determine whether the currently received detection command can be identified. If the currently received detection command can be identified, in other words, the currently received detection command is equal to the predetermined command, the response sending module 214 sends a response to the computer 10 via the communication interfaces 100 and 200. If the currently received detection command cannot be identified, that is, the currently received detection command is not equal to the predetermined command, the currently received detection command is discarded. In one example, a predetermined detection command may have a transmission rate of 9600 bps and an ASCII (N, 7, 2) packet mode. If the currently received detection command matches the predetermined command, it is identified, otherwise it's discarded.

The response receiving module 114 is configured for receiving the response from the driver 20 via the communication interfaces 100 and 200. The computer 10 finishes detecting the communication protocol of the driver 20 if the response receiving module 114 receives the response from the driver 20, and the response receiving module 114 sends a stop command to make the command sending module 112 stop sending detection commands. Thus, communication is established between the computer 10 and the driver 20.

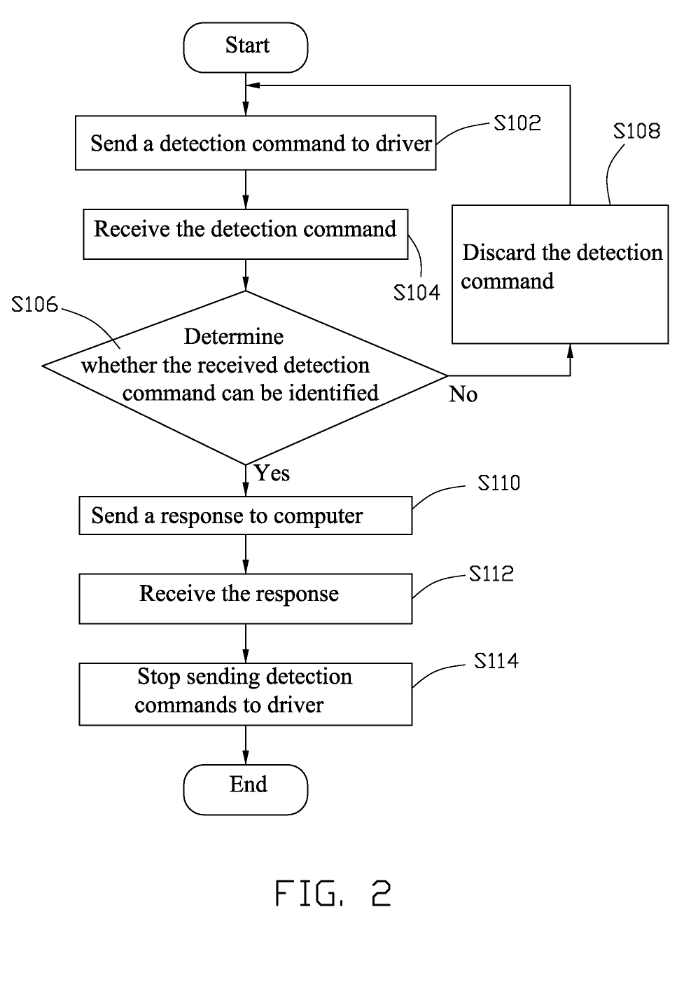

Referring to FIG. 2, an exemplary embodiment of a communication protocol detection method includes the following steps described below.

In step S102, the command sending module 112 sends a detection command stored in the storage device 30 to the driver 20 via the communication interface 100.

In step S104, the command receiving module 212 receives the detection command from the command sending module 112 via the communication interface 200, and sends the received detection command to the response sending module 214.

In step S106, the response sending module 214 determines whether the currently received detection command can be identified or not, if yes, the procedure goes to step S110, if not, the procedure goes to step S108.

In step S108, the response sending module 214 discards the currently received detection command, and the procedure goes to step S102.

In step S110, the response sending module 214 sends a response to the computer 10.

In step S112, the response receiving module 114 receives the response from the driver 20, and sends a stop command to the command sending module 112.

In step S114, the command sending module 112 stops sending detection commands to the driver 20, and communication is established between the computer 10 and the driver 20.

It is to be understood, however, that even though numerous characteristics and advantages of the embodiments have been set forth in the foregoing description, together with details of the structure and function of the embodiments, the disclosure is illustrative only, and changes may be made in details, especially in matters of shape, size, and arrangement of parts within the principles of the embodiments to the full extent indicated by the broad general meaning of the terms in which the appended claims are expressed.

What is claimed is:

1. A communication protocol detection system comprising:
an active detection terminal comprising a first communication interface, a command sending module, and a response receiving module; and
a passive detection terminal comprising a second communication interface, a command receiving module, and a response sending module;
wherein the command sending module is configured for sending a plurality of detection commands in sequence to the passive detection terminal via the first communication interface, the command receiving module is configured for receiving the detection commands in sequence via the second communication interface, and sending the detection commands to the response sending module, the response sending module is configured for determining whether a currently received detection command can be identified, the response sending module sends a response to the active detection terminal to make the command sending module stop sending the detection commands upon a condition that the currently received detection command can be identified.

2. The system of claim 1, wherein the response sending module is further configured for discarding the currently received detection command upon a condition that the currently received detection command can not be identified.

3. The system of claim 1, wherein each detection command comprises a transmission rate and a packet mode.

4. The system of claim 3, wherein the packet mode is an American Standard Code for Information Interchange (ASCII) packet mode.

5. The system of claim 3, wherein the packet mode is a Remote Terminal Unit (RTU) packet mode.

6. The system of claim 3, wherein the response sending module compares the currently received detection command with a predetermined command to determine whether the currently received detection command can be identified, the currently received detection command can be identified upon a condition that the currently received detection command is equal to a predetermined command; the currently received detection command can not be identified upon a condition that the currently received detection command is not equal to the predetermined command.

7. The system of claim 1, further comprising a storage device, wherein the detection commands are stored in the storage device, and each detection command is numbered.

8. A communication protocol detection method, comprising:
providing an active detection terminal and a passive detection terminal;
sending a detection command via the active detection terminal to the passive detection terminal;
receiving the detection command via the passive detection terminal and determining whether the detection command can be identified;
sending another detection command via the active detection terminal to the passive detection terminal upon a condition that the detection command previously sent can not be identified;
sending a response via the passive detection terminal to the active detection terminal upon a condition that the detection command previously sent can be identified; and
receiving the response via the active detection terminal and stopping sending detection commands.

9. The method of claim 8, further comprising:
discarding a detection command received by the passive detection terminal upon a condition that the detection command can not be identified.

10. The method of claim 8, wherein each detection command comprises a transmission rate and a packet mode.

11. The method of claim 10, wherein comparing the detection command previously sent with a predetermined command to determine whether the detection command can be identified, the detection command can be identified upon a condition that the detection command is equal to the predetermined command; or the detection command can not be identified upon a condition that the detection command is not equal to the predetermined command.
